(19) United States
(12) Patent Application Publication
(10) Pub. No.: US 2012/0221455 A1
(43) Pub. Date: Aug. 30, 2012

(54) Complex Order Generation for Trading Financial Instruments Using Order Template Method

(76) Inventor: Siu Fai CHAU, Hong Kong (HK)

(21) Appl. No.: 13/233,044

(22) Filed: Sep. 15, 2011

Related U.S. Application Data
(60) Provisional application No. 61/446,456, filed on Feb. 24, 2011.

(51) Int. Cl. G06Q 40/06

(52) U.S. Cl. 705/37

(57) ABSTRACT

The present invention discloses a system for generating trading orders in a simple way and without the need of programming. The system comprises a user input module adapted to receive user input for an order strategy; a trigger generation module adapted to generate trigger signals and an order management module for generating trading orders based on the trigger signals and the user input. The user input module comprises a user interface using an order template provided in a table format to allow a user to input a trigger for generating the trading order. The system supports automatic mode and manual mode which are switchable by the user.

### CROSS-REFERENCE TO RELATED APPLICATION

This application claims benefit under 35 U.S.C. §119(e) of U.S. Provisional Application Ser. No. 61/446,456 filed 24 Feb. 2011, which is hereby incorporated by reference herein in its entirety.

### FIELD OF INVENTION

This invention relates to a system for generating trading order, and in particular an order management system for trading financial instruments by using order template.

### BACKGROUND OF INVENTION

In modern financial markets, computers are widely used by traders to trade various financial instruments such as stock, future, forex and options. However, it is not easy to generate an order due to complexity of the financial markets nowadays, especially for complex orders supporting advanced trading strategy such as hedging, spread trading, etc. In order to simplify the generation, computer assisted systems are used but it require programming by using programming languages such as C++ and Java. Such programming is also complex and time-consuming and it is not feasible for a trader without programming skill.

### SUMMARY OF INVENTION

In the light of the foregoing background, it is an object of the present invention to provide an alternate system for generating trading orders in a simple way and without the need of programming.

Accordingly, the present invention, in one aspect, is system for generating trading orders comprising: a user input module adapted to receive user input for an order strategy; a trigger generation module adapted to generate trigger signals and an order management module for generating trading orders based on the trigger signals and the user input; wherein the user input module comprises a user interface using an order template provided in a table format, allowing a user to input a trigger for generating the trading order, with a type, a symbol, a price and a quantity of the trading order in the table.

In an embodiment, the system further comprises an external device for providing market data to the trigger generation module. The trigger generation module is adapted to generate trigger signals based on trading rules and formulae predefined by the user. The outputs of trading rules and formulae are Boolean.

In an exemplary embodiment of the present invention, at least one of the trigger, the price and the quantity is defined using a formula, the formula using the trigger signals received from the trigger generation module as input parameters. The trigger signals comprise market data and numerical operators on the market data

In another exemplary embodiment, the order template further comprises a parent order template and at least one child order templates, where the trading order generated from each child order template is conditional to a status of the trading order generated from the parent order template.

In yet another embodiment, the order template further comprises multiple parent order templates. The multiple parent order templates are executed independently.

In another implementation, the user is allowed to override the trigger of the trading order by manual operation. In addition, the user interface is customizable so that the user is allowed to create functional buttons.

According to another aspect of the present invention, it is a method for generating trading orders comprising the steps of: defining trading rules and formulae; generating trigger signals based on the trading rules and formulae; allowing a user to input a trigger for an order strategy by using an order template provided in a table format and generating trading orders based on the trigger signals and the user input; wherein the table comprising a type, a symbol, a price and a quantity of the trading order.

In a variation of the above method, it further comprises providing market data by an external device and defining at least one of the trigger, the price and the quantity using a formula which uses the trigger signals as input parameters.

In an embodiment, the outputs of the trading rules and formulae are Boolean. The trigger signals comprise market data and numerical operators on the market data.

In a further exemplary embodiment, the order template used by the method further comprises a parent order template and at least one child order templates, where the trading order generated from each child order template is conditional to a status of the trading order generated from the parent order template.

In another embodiment, the order template used by the method further comprises multiple parent order templates. The multiple parent order templates are executed independently.

In a further embodiment, the method further comprises allowing the user to override the trigger of the trading order by manual operation and creating functional buttons by using a customizable user interface.

There are many advantages to the present invention. First, the user can easily define an order strategy by simply adjusting parameters in the order template without the need of programming. The user can save a lot of time and create complex strategies by simple adjustments to the table. Moreover, the system supports automatic mode and manual mode. The user can generate trading orders relying on the system but governing by predefined strategies or control all the trading orders by custom buttons.

### BRIEF DESCRIPTION OF FIGURES

FIG. 1 is a diagram showing an implementation overview of the present invention according to an exemplary embodiment.

FIG. 2 shows the system design according to one embodiment of the present invention.

FIG. 3 is an order template table according to an embodiment of the present invention.

FIG. 4 is custom user interface according to one embodiment of the present invention.

FIG. 5 shows the live automatic trading environment of the system according to one embodiment of the present invention.

FIG. 6 shows the live manual trading environment of the system according to one embodiment of the present invention.

### DETAILED DESCRIPTION OF THE PREFERRED EMBODIMENTS

As used herein and in the claims, “comprising” means including the following elements but not excluding others.

As used herein and in the claims, “couple” or “connect” refers to electrical coupling or connection either directly or indirectly via one or more electrical means unless otherwise stated.

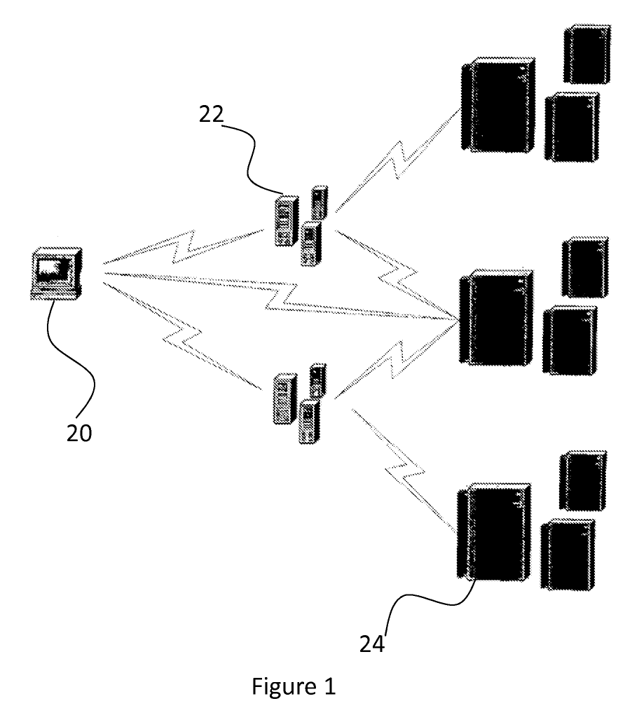

Referring now to FIG. 1, an implementation overview of the present invention is shown according to an exemplary embodiment. The present invention can be implemented on a computer, an electronic device or an electronic terminal 20, etc. The device on which the present invention is implemented, e.g. the computer 20, is able to communicate with one or more brokers 22 or exchanges 24 through wired or wireless channels. The computer or electronic device 20 receives market data from external devices and then generates trading orders to the brokers 22 or exchanges 24 based on the market data and the order strategies defined by a user.

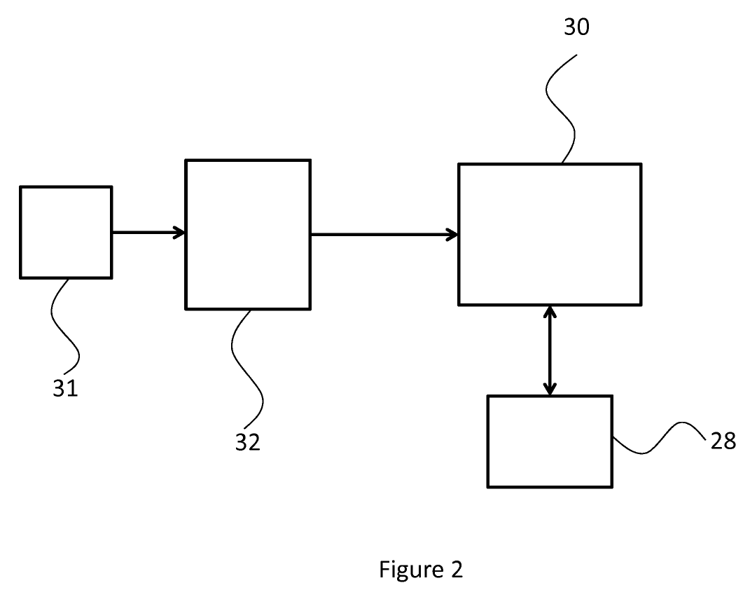

Turning to FIG. 2, the system design according to one embodiment of the present invention is shown. The system comprises a user input module 28 and an order management module 30. The order management module 30 is connected to an output of a trigger generation module 32. The trigger generation module is in turn connected to an output of an external device 31.

In operation of the system, the trigger generation module 32 receives market data for predetermined instruments. When a trigger condition is fulfilled for an instrument, the trigger generation module 32 sends a trigger signal to the order management module 30. Upon receiving the trigger signal, the order management module 30 generates a trading order to be sent to the broker 22 or the exchange 24 (in FIG. 1) based on the information received from the user input module 28.

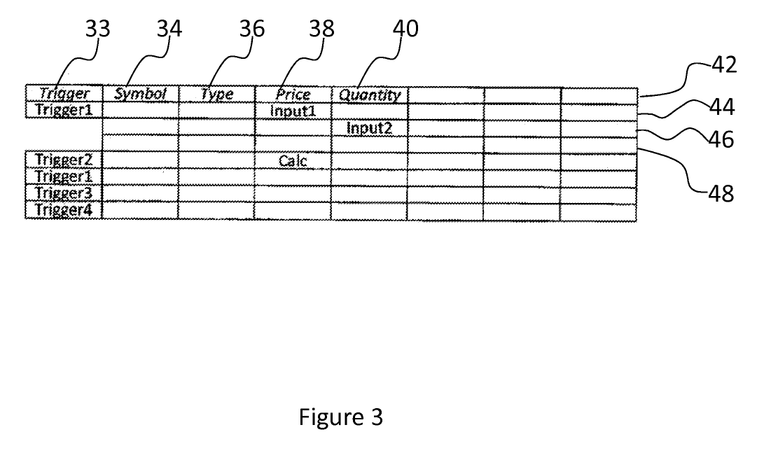

In an exemplary embodiment, the interface of the user input module 28 to the user is an order template provided in a table format. FIG. 3 shows an order template table according to an embodiment of the present invention. The first row in the table is the header row 42 while the remaining rows are the order templates with different parameters that are adjustable by the user. The table can have unlimited number of order template rows. In general, the table contains several adjustable columns including trigger 33, symbol 34, type 36, price 38 and quantity 40. Additional columns, such as remarks or validity period can be added due to the need of the user.

Each field in the order template table mentioned above is editable by the user. By default, the symbol field 34 of the table is BASE which means that the order will be generated on the instrument of the market data feed. For example, if the instrument is MSFT (stock symbol of Microsoft), all the orders generated by the order management module 30 with the symbol field 34 BASE will target to trade MSFT. It is possible that an order template contains symbol for derivative of the BASE instrument. The user can put in Future command or Option command with appropriate parameters such as strike price and expiry month. The order generated by the order template can then trade on relevant option or future of the BASE instrument. This mechanism supports hedging and spread trading strategy. It is also possible to put in a Lookup command and subsequently the order generator will look up another instrument from the database and use that instrument as the trading target, where pair trading strategy is enabled in this way. Other selectable options in the symbol field 34 include EXTERNAL and RELATIVE. EXTERNAL means that the trigger is not to trade the instrument connected but to trade external instruments other than the instrument connected. RELATIVE means that the trigger is to trade instruments relative to the instrument connected but not the instrument connected itself.

The type field 36 in the table indicates the type of order the user selects. Brokers 22 and exchanges 24 support different types of orders. For example, market order means that the broker will execute the order based on the market price while limit buy order means that the broker will execute a buy order if the price is at or lower than the targeted price. By selecting different types, the user can develop different trading strategies.

The price field 38 is used to define the target price for the trading order. The user can choose one of the named inputs or even define a formula for the price field 38. The formula may use the market data, other named inputs and the data input in the boxes of the user interface to calculate the price. And then the value calculated by the formula is used as the targeted price for generating trading orders during the live trading.

Similarly, the user can define the quantity field 40 of the order template by linking it to a named input or defining a formula for it. The quantity field 40 defines the trading quantity of an instrument in a trading order generated during the live trading. The price filed 38 and the quantity field 40 can be linked to user input fields in the order entry form, thus allowing the user to provide data to the price field 38 and the quantity field 40 during order generation.

As shown in FIG. 3, a parent order template 44 may have one or more child order templates (46 and 48). The child order templates (46 and 48) are represented by indented rows under the parent order template row 44. Each parent order template 44 has a trigger field 33, except the child order templates (46, 48) since they belong to the same trigger as the parent order template 44. It means that a single trigger may generate multiple trading orders simultaneously. The trading order generated from each child order template (46, 48) is conditional to a status of the trading order generated from the parent order template. If an order template has child order templates, the system will generate child orders based on the child order templates and submit together with its associated parent order to the brokers 22 or exchanges 24. For example, the parent order template 44 is a buy order of a specific stock while the child order template 46 is a sell order with condition A and the child order template 48 is also a sell order but with condition B. The trading order generated will execute the parent order template 44 first. Only when the parent order template is executed successfully and condition A is satisfied, the child order template 46 will be executed. The same applies to the child order template 48.

In addition to one parent order template linking several child order templates, a trigger may contain multiple parent order templates. Each parent order template in the same trigger can be linked to the same instrument or different instruments and each parent order template is executed simultaneously in parallel, i.e. each parent order template is independent to each other. All the parent order templates within the same trigger will be executed when the trigger is initiated. The difference between parent-child combination and parent-parent combination is that the child order templates in parent-child combination depends on the parent while all the parent order templates are independent to each other in parent-parent combination. The executing forms and conditions can be set or amended by the users at any time, just depending on the strategies defined by the users.

In an exemplary embodiment, the trigger 33 is definable by the user at the trigger generation module 32. The user is allowed to enter the condition for generating the trigger signal for each instrument. The condition can take market data and numerical operators as inputs. For example, the trigger condition can be when a current price of the instrument rises above a 50-day moving average of the instrument. The trigger generation module 32 continuously receives the market data of the specified instrument, and monitors whether the trigger condition is fulfilled. As soon as the trigger condition is fulfilled, the trigger generation module 32 generates the trigger signal and sends to the order management module 30. The market data of the instrument at that time is also sent to the order management module 30 for calculation of price and quantity for the trading order if needed.

The system of the present invention supports automatic mode and manual mode. In the first time use of the system, the user is required to enter trading rules and formulae into the trigger generation module 32 for presetting some criteria so that the trigger generation module 32 will generate a TRUE trigger signal when certain conditions are met. In other words, the outputs of the trading rules and formulae are Boolean, i.e. TRUE or FALSE. The trading rules can be constructed using text based formula designer or graphical based formula designer. Such step is needed in the first time use, but the user is allowed to amend the trading rules and formulae in the trigger generation module 32 at any time. In automatic mode, all trading orders will be generated automatically based on the predefined order strategy set by the user. In this mode, the interaction of human is minimized. The only thing the user needed to do is defining triggers in the order template and presetting parameters according to certain trading strategies. Afterward, all subsequent jobs will be handled by the system. The users can save a lot of time in this way. During live trading, trigger signals are emitted by the trigger generation module 32. The trigger signals will trigger the linked order templates to generate and submit trading orders to the brokers 22 or exchanges 24. The system is also designed to be intelligent that it will not execute the same trigger if the same instrument already exists even though the predefined condition is satisfied again. However, the user is allowed to override this default setting due to his/her own preference. In addition, the user can allow the system to calculate appropriate price and quantity for the trading orders, but not set manually.

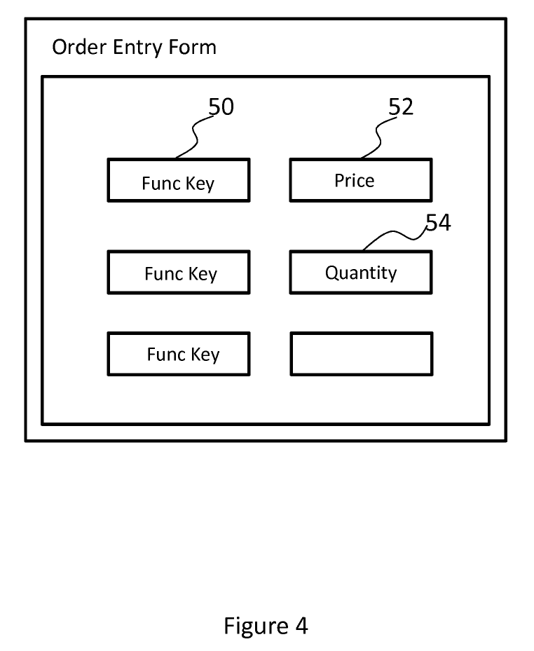

In the manual mode, the user is allowed to override the triggers of the trading orders by manual operation. As shown in FIG. 4, the user can create a custom user interface according to specific needs. In the manual mode, the user can preset buttons in the customizable user interface or programmable keys on the keyboard. For instance, in FIG. 4, the user can define a function key 50 which is linked to a specific trigger in the order template. When the user presses the button of function key 50, the associated trigger will be executed and a corresponding trading order is generated to the brokers 22 or exchanges 24. The user can also create a price button 53 or a quantity button 54 for entering the target price and quantity of an instrument by real time input to fully control the trading order generated. The user can customize function keys and parameter buttons as many as he/she wants to satisfy his/her personal need. The design of the custom user interface, the function keys and other buttons can be saved within the system of the present invention so that the user can reuse the saved design by simply reloading it from the database of the system, avoiding the need of reproducing a mature design. By using such configuration, the user can choose to trigger order templates using the predefined buttons at any time. As mentioned above, the user can customize programmable keys on the keyboard. In this way, the user can submit multiple orders by pressing a single key or a single mouse button click. Adopting this mechanism, the traders can build up complex orders such as hedging, spread trading and other advanced trading strategies by simple design.

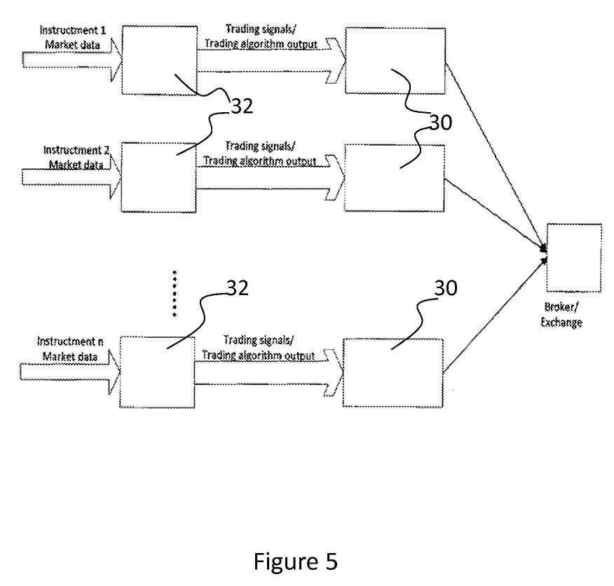

Referring now to FIG. 5, the live automatic trading environment of the system is shown according to one embodiment of the present invention. As shown in FIG. 5 (the data input module 26 and the user input module 28 are omitted), the system of the present invention is not limited to trade a single instrument. It supports trading multiple instruments simultaneously. The system will create an independent process for each instrument and each process will be performed in parallel. The market data of each instrument will be fed to the corresponding trigger generation module 32 directly. The trigger generation module 32 will then generate trigger signals and trading algorithm output data to the associated order management module 30 which generates trading orders for the associated instrument to the brokers 22 and exchanges 24. Unlimited number of order management modules 30 can be integrated into a single device (a computer, a terminal or other electronic devices 20). The system of the present invention can create any number of order management modules 30 due to the actual need by multi-threading. Each order management module 30 functions independently and will not affect each other.

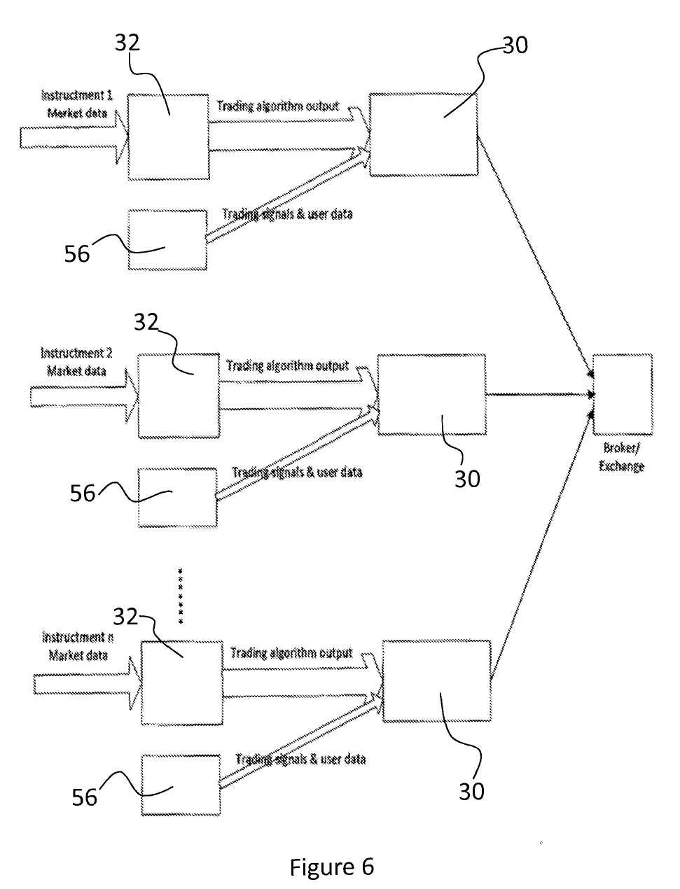

Now turning to the manual trading, FIG. 6 (the data input module 26 and the user input module 28 are omitted) shows the live manual trading environment according to one embodiment of the present invention. It is quite similar to the live automatic trading environment, except there are custom user interfaces 56 created by the users. Again, the system of the present invention in manual mode is not limited to trade a single instrument. It supports trading multiple instruments simultaneously. The system will create an independent process for each instrument and each process will be performed in parallel. The market data of each instrument will be fed to the corresponding trigger generation module 32 directly. The trigger generation module 32 will then generate trigger signals and trading algorithm output data to the associated order management module 30. However, the trading orders generated are controlled by the users using custom user interfaces 56. The users can decide when to trigger a specific order template, how much the price is and how many the quantity is, etc. On the other hand, the users may leave the order management module 30 to user the trading algorithm output data to generate the targeted price and/or quantity. By simply pressing the buttons on the custom user interfaces 56 or pressing the programmable keys on the keyboard, the trading orders for the associated instruments are generated to the brokers 22 and exchanges 24.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, the system of the present invention can be implemented on any existing or future terminals or devices with the capability to perform the functions described herein. Any existing or future functions, statements or algorithms can be integrated into the order management module 28 so as to expand the functionality of the system.

The main advantage of the present invention is that the user can save a lot of time and build complex and advanced trading strategies by simply defining some basic parameters without complex programming. By simply changing parameters, the trading strategies can be changed immediately. By using different combinations of the order templates, any wanted strategies can be created by several button presses. By creating different custom user interfaces, any functions can be controlled in hand.

What is claimed is:

1. A system for generating trading orders comprising:
a) a user input module adapted to receive user input for an order strategy;
b) a trigger generation module adapted to generate trigger signals; and
c) an order management module adapted to generate trading orders based on said trigger signals and said user input;
wherein said user input module comprises a user interface using an order template provided in a table format, allowing a user to input a trigger for generating said trading orders, with a type, a symbol, a price and a quantity of said trading orders in said table.

2. The system of claim 1 further comprises an external device for providing market data to said trigger generation module.

3. The system of claim 1, wherein said trigger generation module is adapted to generate trigger signals based on trading rules and formulae predefined by the user.

4. The system of claim 3, wherein the outputs of said trading rules and formulae are Boolean.

5. The system of claim 1, wherein at least one of said trigger, said price and said quantity is defined using a formula, said formula using said trigger signals received from said trigger generation module as input parameters.

6. The system of claim 1, wherein said trigger signals comprise market data and numerical operators on said market data.

7. The system of claim 1 wherein said order template further comprising a parent order template and at least one child order templates, where said trading order generated from each said child order template is conditional to a status of said trading order generated from said parent order template.

8. The system of claim 1 wherein said order template further comprising multiple parent order templates, said multiple parent order templates are executed independently.

9. The system of claim 1, wherein said user is allowed to override said trigger of said trading order by manual operation.

10. The system of claim 1, wherein said user interface is customizable so that the user is allowed to create functional buttons.

11. A method for generating trading orders comprising:
a) defining trading rules and formulae;
b) generating trigger signals based on said trading rules and formulae;
c) allowing a user to input a trigger for an order strategy by using an order template provided in a table format; and
d) generating trading orders based on said trigger signals and said user input;
wherein said table comprising a type, a symbol, a price and a quantity of said trading order.

12. The method of claim 11 further comprises providing market data by an external device.

13. The method of claim 11, wherein the outputs of said trading rules and formulae are Boolean.

14. The method of claim 11 further comprising defining at least one of said trigger, said price and said quantity using a formula which uses said trigger signals as input parameters.

15. The method of claim 11, wherein said trigger signals comprise market data and numerical operators on said market data.

16. The method of claim 11 wherein said order template further comprising a parent order template and at least one child order templates, where said trading order generated from each said child order template is conditional to a status of said trading order generated from said parent order template.

17. The method of claim 11 wherein said order template further comprising multiple parent order templates, said multiple parent order templates are executed independently.

18. The method of claim 11 further comprises allowing said user to override said trigger of said trading order by manual operation.

19. The method of claim 11 further comprises creating functional buttons by using a customizable user interface.
